(19) United States
(12) Patent Application Publication
(10) Pub. No.: US 2026/0322588 A1
(43) Pub. Date: Oct. 15, 2026

(54) SERVER, AUTHENTICATION SYSTEM, AUTHENTICATION METHOD, AND PROGRAM

(71) Applicant: NEC Corporation, Minato-ku, Tokyo (JP)

(72) Inventors: Toshiyuki ISSHIKI, Tokyo (JP); Haruna FUKUDA, Tokyo (JP); Kengo MORI, Tokyo (JP)

(73) Assignee: NEC Corporation, Minato-ku, Tokyo (JP)

(21) Appl. No.: 19/109,357

(22) PCT Filed: Sep. 16, 2022
(86) PCT No.: PCT/JP2022/034780

§ 371 Date: Mar. 6, 2025

(51) Int. Cl. H04L 9/08; G06Q 20/38; G06Q 20/40; H04L 9/30

(52) U.S. Cl. CPC H04L 9/0825; H04L 9/0861; H04L 9/30; H04L 63/0861

(57) ABSTRACT

A server includes: a storage part that stores an encrypted first feature(s); an acquisition part that acquires a second feature received and encrypted by a terminal; a calculation part that calculates a similarity based on the first feature(s) and the second feature; and a conversion and transmission part that converts the similarity into a similarity in a format that can be decrypted by a different server, and transmits the converted similarity to the different server.

### TECHNICAL FIELD

The present invention relates to a server, an authentication system, an authentication method, and a program.

### BACKGROUND ART

Saas (Software as a Service) can be provided per account if there are a terminal apparatus(es) and an Internet environment. If a plurality of accounts are provided, it is possible to provide a service(s) to a plurality of users. Because of this convenience and aggregation, various kinds of services have been provided.

As described above, with SaaS, a plurality of users can access a server via the Internet by using their accounts, and can receive a service(s) based on application software. In the case of a large-scale SaaS, there are users on a scale larger than organizations such as companies and departments. In this case, it is an issue to ensure the inter-account security. In particular, to prevent unauthorized access to confidential information, etc., it is necessary to strictly manage the passwords and IDs used in account authentication situation.

Recent years have seen more cases in which biometric authentication is introduced instead of using IDs and passwords, so as to prevent unauthorized access. However, regarding biometric authentication, once the biometric feature is leaked, other services using the leaked biometric authentication can be accessed. Therefore, care needs to be taken, for example, in handling the so-called templates, which are the matching destinations in biometric authentication, and in handling the biometric features acquired at authentication. In particular, when authentication is executed based on SaaS, because the data of the biometric authentication templates used at account registration and the data of the features acquired at authentication are sent to a service provider, there is a security issue. In addition, if the features are not encrypted, because a service operator can determine who has executed authentication on which services, the privacy issue needs to be taken into consideration.

### CITATION LIST

### Patent Literature

PTL 1: Japanese Unexamined Patent Application No. 2008-021295

### SUMMARY

### Technical Problem

The disclosure of PTL 1 is incorporated herein by reference thereto. The following analysis has been made by the present inventors.

The invention disclosed in PTL 1 enables a matching process in a matching service for the members between groups while keeping the identification numbers of the users encrypted. PTL 1 discloses a program that is executed by a service provider and that can execute a matching process without letting third parties including the service provider know the matching results.

However, according to the invention disclosed in PTL 1, the user identification IDs in a list included in matching query information are encrypted by a symmetric key encryption technique. In addition, a list in which identification IDs are arranged according to priority is encrypted with the public key of a server of the service provider. That is, encryption is executed in two stages. In addition, after a matching result is modified with modification information included in a query, the matching result is transmitted to a relay computer. Therefore, if this technique is introduced to an authentication service, the processing speed will be an issue.

In addition, the relay computer generates an encryption key based on a symmetric key encryption technique. Thus, if this technique is used with a user terminal, it is necessary to deliver a secret key, and therefore, there is a risk in terms of security. In particular, once a secret key is acquired in an unauthorized manner, it is likely to cause a significant impact on cases such as authentication services in which many terminals are used.

Thus, it is an object of the present invention to provide a server, an authentication system, an authentication method, and a program that contribute to ensuring high-speed processing, high-level security, and privacy in an authentication service.

### Solution to Problem

According to a first aspect of the present invention or disclosure, there is provided a server including: a storage part that stores an encrypted first feature(s); an acquisition part that acquires a second feature received and encrypted by a terminal; a calculation part that calculates a similarity based on the first feature(s) and the second feature; and a conversion and transmission part that converts the similarity into a similarity in a format that can be decrypted by a different server, and transmits the converted similarity to the different server.

According to a second aspect of the present invention or disclosure, there is provided an authentication system, including: a server; and a different server; wherein the server includes a storage part that stores an encrypted first feature(s); an acquisition part that acquires a second feature received and encrypted by a terminal, a calculation part that calculates a similarity based on the first feature(s) and the second feature, and a conversion and transmission part that converts the similarity into a similarity in a format that can be decrypted by a different server, and transmits the converted similarity to the different server; wherein the acquisition part acquires a user ID(s) that determines a user(s) in association with the first feature(s); wherein the calculation part calculates the similarity based on the encrypted first feature(s) and the encrypted second feature, each of which is encrypted; wherein the conversion and transmission part transmits the similarity to the different server in association with the corresponding user ID; and wherein the different server decrypts the similarity and acquires one user ID based on the similarity and a predetermined reference.

According to a third aspect of the present invention or disclosure, there is provided an authentication method, including: a step of causing a computer to store an encrypted first feature(s); a step of causing the computer to acquire a second feature received and encrypted by a terminal; a step of causing the computer to calculate a similarity based on the first feature(s) and the second feature; and a step of causing the computer to convert the similarity into a similarity in a format that can be decrypted by a different server, and to transmit the converted similarity to the different server.

According to a fourth aspect of the present invention or disclosure, there is provided a program, causing a computer to execute: a process for storing an encrypted first feature(s); a process for acquiring a second feature received and encrypted by a terminal; a process for calculating a similarity based on the first feature(s) and the second feature; and a process for converting the similarity into a similarity in a format that can be decrypted by a different server, and transmitting the converted similarity to the different server.

### Advantageous Effects of Invention

According to the individual aspects of the present invention or disclosure, the present invention provides a server, an authentication system, an authentication method, and a program that contribute to ensuring high-speed processing, high-level security, and privacy in an

### BRIEF DESCRIPTION OF DRAWINGS

FIG. 1 is a block diagram illustrating an example of a configuration of a server according to an example embodiment.

FIG. 2 is a schematic diagram illustrating an overview of a process of a server according to a first example embodiment.

FIG. 3 is a block diagram illustrating an example of a configuration of the server according to the first example embodiment.

FIG. 4 is a flowchart illustrating an operation (generation of keys and storage of a registration feature) of the server according to the first example embodiment.

FIG. 5 is a flowchart illustrating an operation (matching process) of the server according to the first example embodiment.

FIG. 6 is a schematic diagram illustrating a hardware configuration of the server according to the first example embodiment.

FIG. 7 is a block diagram illustrating an example of a configuration of a server according to a second example embodiment.

FIG. 8 is a sequence diagram illustrating an example of an operation (generation of keys) of the server according to the second example embodiment.

FIG. 9 is a sequence diagram illustrating an example of an operation (registration of a feature) of the server according to the second example embodiment.

FIG. 10 is a sequence diagram illustrating an example of an operation (matching) of the server according to the second example embodiment.

FIG. 11 is a sequence diagram illustrating an example of another operation (generation of keys) of the server according to the second example embodiment.

FIG. 12 is a sequence diagram illustrating an example of another operation (matching) of the server according to the second example embodiment.

### EXAMPLE EMBODIMENTS

### Overview of Process According to One Example Embodiment

First, an overview of a process according to an example embodiment will be described. In the following overview, various components are denoted by reference signs for the sake of convenience. That is, the following reference signs are used only as examples to facilitate understanding of the present invention. Thus, the description of the overview is not intended to impose any limitations. An individual connection line between blocks in the drawings signifies both one-way and two-way directions. An arrow schematically illustrates a principal signal (data) flow and does not exclude bidirectionality. In addition, while not explicitly illustrated in the circuit diagrams, the block diagrams, the internal configuration diagrams, the connection diagrams, etc., in the disclosure of the present application, an input port and an output port exist at an input end and an output end of an individual connection line. The same holds true for the input-output interfaces.

### Configuration According to One Example Embodiment

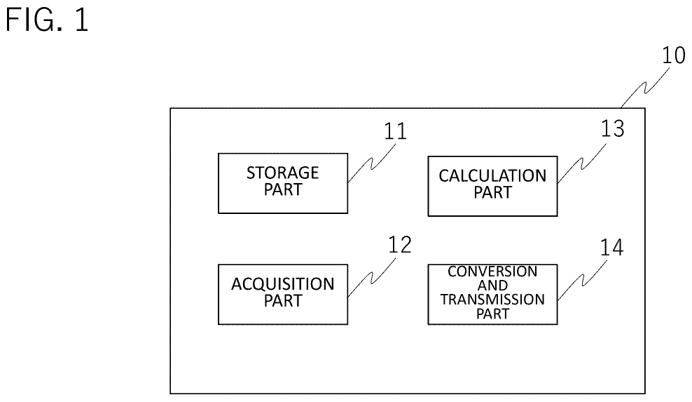

Next, a configuration of a server according to an example embodiment will be described with reference to a drawing. FIG. 1 is a block diagram illustrating an example of a configuration of a server according to an example embodiment. As illustrated in FIG. 1, a server 10 according to an example embodiment includes a storage part 11, an acquisition part 12, a calculation part 13, and a conversion and transmission part 14.

The storage part 11 stores an encrypted first feature(s). The acquisition part 12 acquires a second feature received and encrypted by a terminal. The calculation part 13 calculates a similarity based on the first feature(s) and the second feature. The conversion and transmission part 14 converts the similarity into a similarity in a format that can be decrypted by a different server, and transmits the converted similarity to the different server.

In biometric authentication, the server according to the example embodiment can calculate the similarity between the first feature(s), which is used as a so-called template(s), and the second feature, which is acquired from a terminal and which is authentication query information used for authentication, and can convert the similarity into a similarity in a format that can be decrypted by a different server. In other words, the calculated similarity can be converted with a key such that the converted similarity can be decrypted by a different server. For example, by converting the calculated similarity into a feature encrypted with a key such that the similarity can be decrypted with a secret key that is present on a service provision server, which is a different server, it is possible to execute an authentication process while keeping the first and second features secret, each of which is encrypted.

Hereinafter, specific example embodiments will be described in more detail with reference to drawings. In the following example embodiments, the same components will be denoted by the same reference signs, and redundant description thereof will be omitted.

### First Example Embodiment

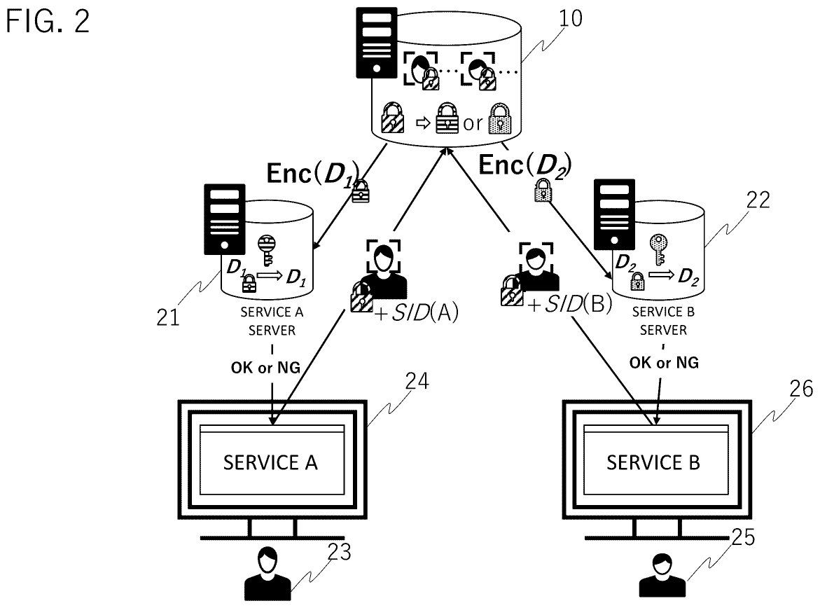

FIG. 2 is a schematic diagram illustrating an overview of a process of a server according to a first example embodiment. As illustrated in FIG. 2, there are a server 10 that executes an authentication process, a server 21 that provides a service A, and a server 22 that provides a service B. The server 10 provides an authentication service as SaaS. An encrypted authentication feature(s) has been registered and stored in the server 10 in advance. Although FIG. 2 illustrates, as an example, the two services A and B for one authentication SaaS, the number of services is not limited to 2.

A user 23, who wishes to use the service A, enters biometric information by using a terminal 24. For example, in the case of face authentication, the user 23 faces a camera and enters an image of his or her face to the terminal. The terminal extracts a feature from the entered image and encrypts the feature. The terminal transmits the encrypted feature as an authentication query along with a service ID “A” to the server 10 serving as an authentication server.

The server 10 calculates a similarity with respect to the registered feature(s). This calculation is executed between the registered feature(s) and the feature in the authentication query. Because these two kinds of features have been encrypted by homomorphic encryption, the calculation can be executed without decrypting the features. A similarity D₁, which is the calculation result, has been encrypted with a key of the authentication service. By using a technique of proxy re-encryption, the key of the authentication service is converted into a key of the service A. Enc(D₁) obtained as a result of the conversion is transmitted to the server 21 providing the service A and is decrypted by the server 21.

The server 21 determines whether the decrypted D₁ is within a predetermined value range, that is, in an acceptance range. If D₁ is within the acceptance range, the server 21 transmits a successful authentication message to the terminal 24 and permits provision of the service A. If D₁ is not within the acceptance range, the server 21 transmits an unsuccessful authentication message and ends the series of steps in the authentication process.

A user 25, who wishes to use the service B, also executes a similar process. The differences are that a terminal 26 transmits a service ID “B” along with an authentication query to the server 10 and that the server 10 converts the key of the authentication service into a key of the service B and transmits an encrypted similarity Enc(D₂) to the server 22.

As described above, by calculating the similarity between the registered feature(s) and the feature in the authentication query without executing decryption, the server 10, which is a service provider, can execute the authentication process while keeping these data secret. In addition, since the server 10 directly converts the key used in the encrypted similarity calculated into a key of a corresponding service, the server 10 does not need to execute decryption and execute encryption again with the key of a corresponding service. Therefore, high-speed processing can be executed.

### Configuration According to First Example Embodiment

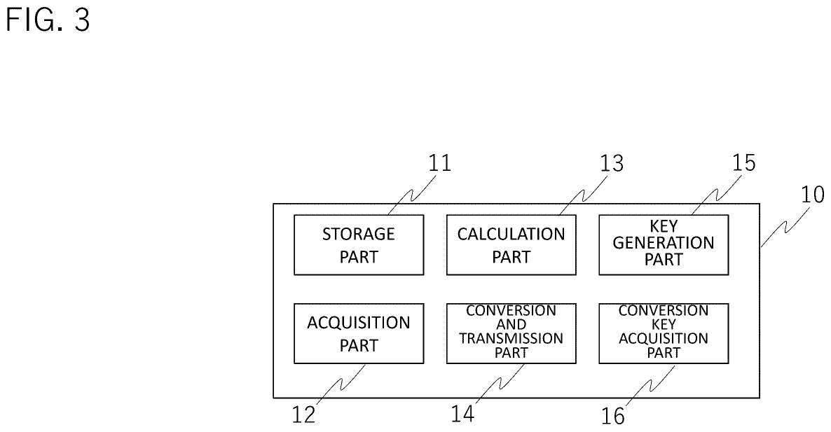

Next, a configuration of the server 10 according to example embodiment 1 will be described with reference to a drawing. FIG. 3 is a block diagram illustrating an example of a configuration of the server 10 according to the present example embodiment. As illustrated in FIG. 3, the server 10 according to the first example embodiment includes a storage part 11, an acquisition part 12, a calculation part 13, a conversion and transmission part 14, a key generation part 15, and a conversion key acquisition part 16.

The storage part 11 stores an encrypted first feature(s). The first feature(s) may be “encrypted” by any one of various kinds of techniques. Although the server according to the present example embodiment adopts a public key encryption technique, the server may adopt a symmetric key encryption technique. However, because a secret key needs to be delivered, and this delivery involves a security issue, it is desirable to adopt a public key encryption technique. The “first feature(s)” is a so-called template(s) that is matched against biometric information, and the number of first features is at least the number of users registered in advance.

The storage part 11 may store a user ID(s) (used for a corresponding service(s)) that determines a user, in association with the encrypted first feature(s).

The acquisition part 12 acquires a second feature received and encrypted and by a terminal. The second feature is included in an authentication query used for authentication. At least, the second feature needs to be encrypted with the same key as that used for the encryption of the first feature(s). The terminal acquires biometric information and extracts a feature based on the biometric information. The extracted feature is encrypted and transmitted to the server 10. The server 10 receives the encrypted feature, and transmits this encrypted feature to the calculation part 13 without decrypting the encrypted feature.

The calculation part 13 calculates a similarity based on the first feature(s) and the second feature. Generally, for example, the distance between a first feature vector and a second feature vector is used as the similarity. For example, any one of various kinds of similarities such as the Euclidean distance, Hamming distance, cosine similarity, and squared Euclidean distance may be used.

In the present example embodiment, to execute the matching between the encrypted features, for example, homomorphic encryption, homomorphic operation, etc., are used. For example, an encryption technique called Somewhat homomorphic encryption is a homomorphic encryption having homomorphism regarding an arbitrary number of additions and an infinite number of multiplications (when ciphertexts Enc(m₁) and Enc(m₂) of plaintexts m₁ and m₂ are given, the homomorphic encryption enables calculation of a ciphertext Enc(m₁○m2) of a binary operation m○m₂ of the plaintexts m₁ and m₂, without decrypting the ciphertexts Enc(m₁) and Enc(m₂) to plaintexts m₁ and m₂. The above “○” represents a binary operation such as addition “+” or multiplication “×”). Thus, the homomorphic encryption can be applied to similarity calculation, etc., executed by matching means in the calculation part 13.

The conversion and transmission part 14 converts the similarity into a similarity in a format that can be decrypted by a different server, and transmits the converted similarity to the different server. In the above, the first feature(s) and the second feature have been encrypted with a key generated by the server 10, which is an authentication server. The conversion and transmission part 14 converts this key into a key such that the similarity can be decrypted by a service provider server, and transmits the similarity to the service provider server.

The server according to the present example embodiment executes the key conversion by using a proxy re-encryption technique, for example. This proxy re-encryption technique is a technique that can convert a ciphertext encrypted with one key into a ciphertext encrypted with another key without acquiring plaintext information. Herein, this technique is used to convert the public key of the server 10 into a public key generated by a service provider server without executing decryption. Herein, there are two pairs of public-key-encryption keys, which are expressed by (public key1, secret key1)=(pk₁, skᵢ) and (public key2, secret key2)=(pk₂, sk₂). A conversion key is generated to execute the proxy re-encryption. When the conversion key is expressed by ReKey, the conversion key generation process rk=ReKey Gen() is expressed by ReKeyGen(pk₂, sk₁)=rk_{1→2}, in which pk₂ represents the ciphertext public key of the conversion destination and sk₁ represents the ciphertext secret key of the conversion source.

The key generation part 15 generates a pair of a secret key and a public key. The generated public key is delivered to an individual terminal receiving a service. The above-described first feature(s) is encrypted with the generated public key at template registration, and the second feature is encrypted with the generated public key at authentication.

The conversion key acquisition part 16 acquires a conversion key from the secret key generated by the key generation part and a key acquired from a different server. For example, the conversion key acquisition part 16 generates a conversion key from the secret key generated by the server 10 and the public key corresponding to a service provided by a different server. For example, assuming that the secret key of the server 10 is sk₁ and the public key corresponding to the service is pk₂, the conversion key generated is expressed by ReKey Gen(pk₂, sk₁)=rk_{1→2}, as described above. The generated conversion key rk_{1→2} is sent to the conversion and transmission part 14.

Although the above-described conversion key used in the proxy re-encryption technique enables a conversion in one way, there is also a conversion key that enables a conversion in two ways. In the latter case, as expressed by ReKeyGen(sk₁, sk₂)=rk_{1→2}, both the secret key of the conversion destination and the secret key of the conversion source are needed. In the case of the server according to the present example embodiment, because the secret key of the user would need to be delivered from the different server to the server 10, a security issue would arise. Thus, it is desirable to adopt the above-described one-way conversion model. Assuming that a plaintext feature to be encrypted is M, the process of the conversion key is expressed by ReEnc(rk_{1→2}, Enc(pk₁, M))=Enc(pk₂, M).

The acquisition part 12 in the server 10 may acquire a user ID that determines the user, such as a user ID of a service being provided by the different server, in association with the second feature. In addition, the conversion and transmission part 14 may transmit the calculated similarity to the different server in association with the above-described user ID.

### Operation

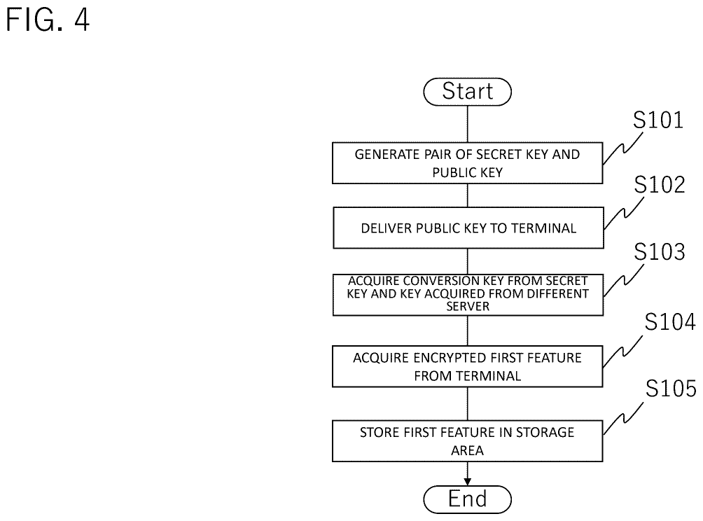

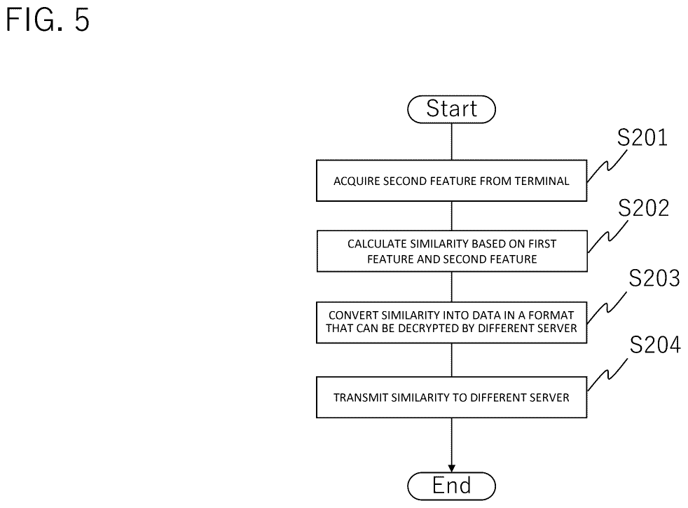

FIGS. 4 and 5 are each a flowchart illustrating an example of an operation of the server 10 according to the present example embodiment. The authentication service is mainly divided into three processes of generation of keys, storage of registration features, and matching. FIG. 4 illustrates an example of an operation of generating keys and storing registration features, and FIG. 5 illustrates an example of an operation of matching.

As illustrated in FIG. 4, first, the server 10 generates a pair of a secret key and a public key (step S101). Of these generated keys, the server 10 delivers the public key to an individual terminal (step S102). Next, the server 10 acquires the secret key and a public key (or a secret key) generated by a different server, which is a service provision server, to generate and acquire a conversion key (step S103). Next, the server 10 acquires a first feature acquired and encrypted by the individual terminal (step S104). The server 10 stores the acquired first feature in its storage area (step S105).

As illustrated in FIG. 5, first, the server 10 acquires a second feature from a terminal (step S201). Next, the server 10 calculates a similarity based on the first feature and the second feature (step S202). Next, the server 10 converts the similarity into a similarity in a format that can be decrypted by the different server. After the conversion, the server 10 transmits the encrypted similarity to the different server, which is a service provision server (S204).

### Hardware Configuration

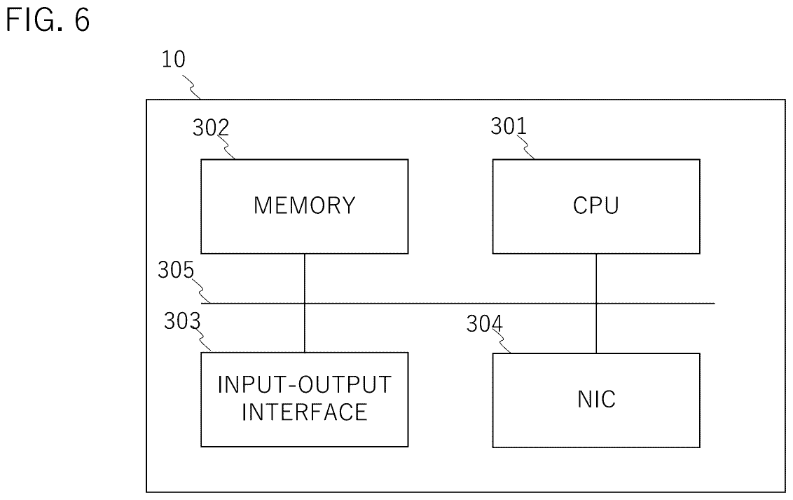

The server 10 according to the present example embodiment can be realized by an information processing apparatus (a computer). The server 10 has a configuration illustrated as an example in FIG. 6. That is, the server 10 includes, for example, a CPU (Central Processing Unit) 301, a memory 302, an input-output interface 303, and a NIC (Network Interface Card) 304, which serves as communication means. These components are connected to each other via an internal bus 305.

The configuration illustrated in FIG. 6 is not intended to limit the hardware configuration of the server. The server 10 may include other hardware not illustrated or may be configured without the input-output interface 303 as appropriate. For example, the number of CPUs included in the server 10 is not limited to the example illustrated in FIG. 6. For example, a plurality of CPUs may be included in the server 10. The memory 302 is a RAM (Random Access Memory), a ROM (Read Only Memory), or an auxiliary storage device (a hard disk or the like).

The input-output interface 303 is means serving as an interface for a display device or an input device not illustrated. The display device is, for example, a liquid crystal display or the like, and the input device is, for example, a camera or a sensor that receives biometric information and a device such as a keyboard or a mouse that receives user operations.

The functions of the server 10 are realized by a group of programs (processing modules) such as a storage program, an acquisition program, a calculation program, a conversion and transmission program, a key generation program, and a conversion key acquisition program and by a group of data such as parameters used by the individual programs. These programs and data are stored in the memory 302. The processing modules are each realized, for example, when the CPU 301 executes a program stored in the memory 302. The individual program can be updated by downloading a program update via a network or by using a storage medium storing a program update. In addition, the above-described processing modules may be realized by semiconductor chips. That is, the present example embodiment includes means for executing the functions of the above-described processing modules by using some hardware and/or software.

### Hardware Operation: at Key Generation

The server 10 invokes the key generation program from the memory 302, and the program becomes executable by the CPU 301. The program generates a pair of a public key and a secret key of the server 10 providing authentication SaaS, and stores the pair of keys in the memory 302. In addition, the server 10 invokes the conversion key acquisition program from the memory 302, and the program becomes executable by the CPU 301. This program receives a public key (or secret key) of a different server providing a service from this different server via the NIC 304, and generates a conversion key by using the received key and the secret key of the server 10. The generated conversion key is temporarily stored in the memory 302.

### At Registration of First Feature

The server 10 invokes the storage program from the memory 302, and the program becomes executable by the CPU 301. This program receives an encrypted first feature, which will be compared with a feature in an authentication query, from a user terminal via the NIC 304, and stores the encrypted first feature in the memory 302.

### At Matching

Upon completion of the key generation and the registration of the encrypted first feature, the server 10 invokes the acquisition program from the memory 302, and the program becomes executable by the CPU 301. This program receives an encrypted second feature about biometric information acquired by a user terminal via the NIC 304. Next, the server 10 invokes the calculation program from the memory 302, and the program becomes executable by the CPU 301. This program calculates the similarity between the encrypted first feature stored in the memory 302 and the acquired encrypted second feature, without decrypting the encrypted features.

Next, the server 10 invokes the conversion and transmission program from the memory 302, and the program becomes executable by the CPU 301. This program reads out the conversion key temporarily stored in the memory 302 and the calculated similarity, and converts the public key of the server 10, the public key having been used for encryption of the calculated similarity, into the public key generated by the server of the corresponding service. The program transmits the encrypted similarity converted to the different server, which is the server providing the corresponding service, via the NIC 304.

The different server decrypts this converted encrypted similarity, which has been transmitted from the server 10, with its secret key, and determines whether the similarity falls within an acceptance range.

### Advantageous Effects

When the server 10 according to the present example embodiment provides an authentication service based on biometric information as SaaS, the server 10 can execute an authentication process while keeping data secret from the SaaS provider, and can protect high-level security and privacy. In addition, the server 10 can realize a high-speed authentication process by converting the key used for the encrypted similarity with a conversion key.

### Example Embodiment

An authentication system according to the present example embodiment is based on the authentication server according to the first example embodiment. In addition, the authentication system is an authentication system in which authentication can be executed for a service being provided by a different server by causing the different server to decrypt an encrypted similarity and to determine whether the similarity is within an acceptance range.

### Configuration According to Second Example Embodiment

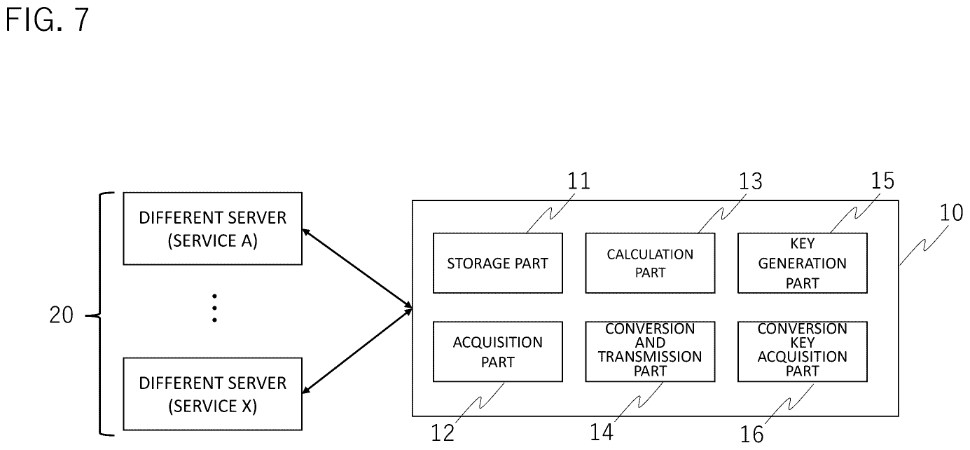

FIG. 7 is a block diagram illustrating a configuration of the authentication system according to the second example embodiment. As illustrated in FIG. 7, a server according to the present example embodiment includes a group of different servers 20 and a server 10. In this configuration, there are a plurality of different servers 20, and a single server 10 is in charge of authenticating a plurality of services. The configuration of the server 10 is the same as the above-described configuration, that is, the server 10 includes a storage part 11, an acquisition part 12, a calculation part 13, a conversion and transmission part 14, a key generation part 15, and a conversion key acquisition part 16. Each of the services (services A to X) is provided by at least one of the different servers 20.

The configuration of the server 10 has already been described above, and redundant description thereof will be omitted. The group of different servers 20 each acquire a similarity encrypted by the server 10 and decrypt the similarity. As a result of the decryption, if the similarity is a value within a predetermined acceptance range, the terminal is notified of a successful authentication message. On the other hand, if the similarity is a value outside the predetermined acceptance range, the terminal is notified of an unsuccessful authentication message.

If the storage part in the server 10 stores a user ID(s) of a service user(s) in association with a first feature(s), the group of different servers 20 may acquire one user ID based on the similarity and a predetermined reference. For example, a process for acquiring a user ID associated with a feature indicating the highest similarity may be executed. The user ID obtained by this process may be used as the login ID for a service being executed by a different server 20.

In addition, based on an authentication result, a corresponding one of the group of different servers 20 may acquire payment information including a user ID as described above, may transmit the payment information to a payment server, and may receive payment result information from the payment server.

### System Operation

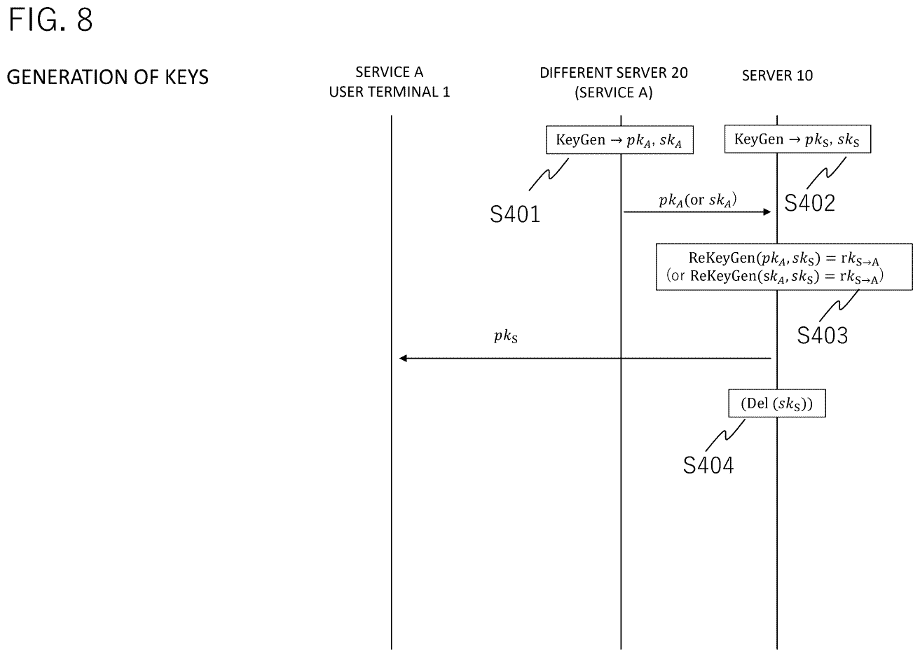

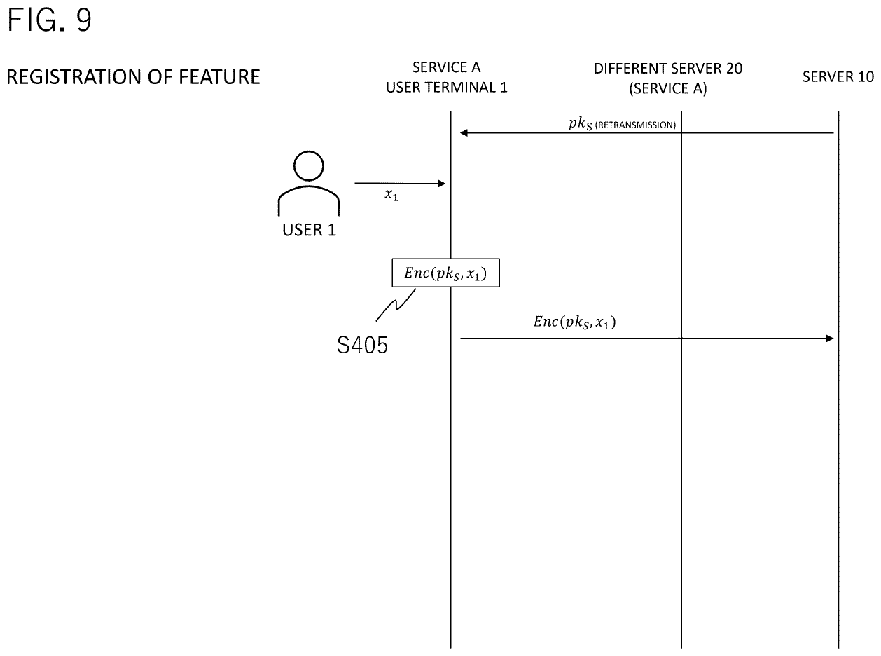

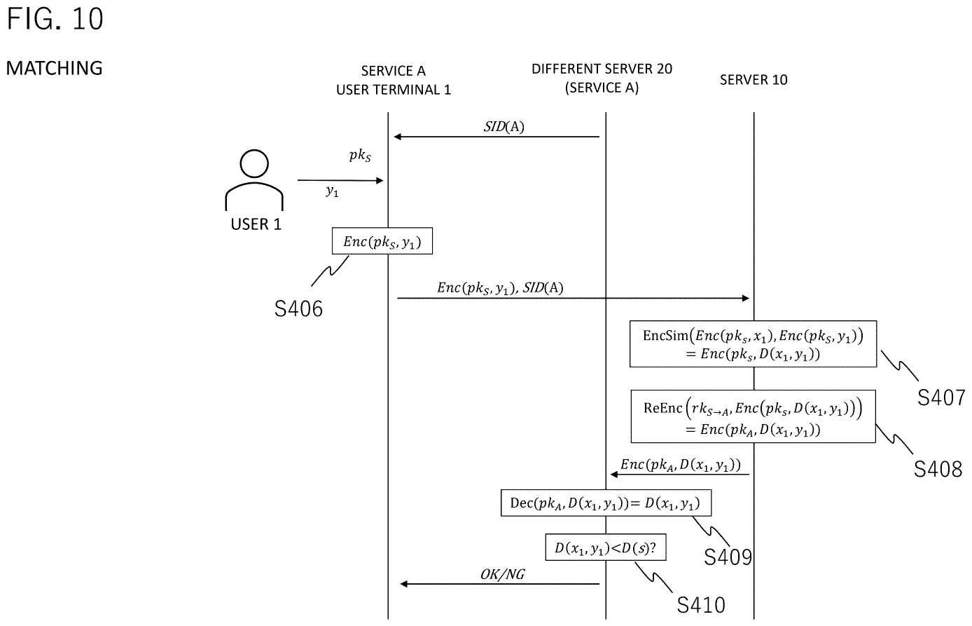

FIGS. 8 to 10 are each a sequence diagram illustrating an example of an operation of the server according to the second example embodiment. FIG. 8 illustrates an example of an operation of generating keys, and FIG. 9 illustrates an example of an operation of registering a first feature. FIG. 10 illustrates an example of an operation of matching a second feature against the first feature.

### System Operation: At Key Generation

As illustrated in FIG. 8, when the system starts its operation, a different server 20 corresponding to the service A generates a pair of a public key and a secret key (pk_{A}, sk_{A}) (step S401), and the server 10 generates a pair of a public key and a secret key (pk_{S}, sk_{S}) (step S402). Next, the different server 20 transmits the public key pk_{A} (or sk_{A}) to the server 10. The server 10 generates a conversion key rk_{S→A} by using its secret key sk_{S} and the received public key pk_{A} (step S403). The server 10 transmits the generated public key pk_{S} to a user terminal 1. If any more services are not added, that is, if the number of different servers 20 does not increase, the secret key k_{S} may be deleted (step S404).

### At Registration of Template

As illustrated in FIG. 9, the server 10 transmits its public key to the user terminal 1 of the service A (retransmission). The user terminal 1 wishing to receive the service A acquires a biometric feature x₁ of a user 1. The acquired x₁ is encrypted by the transmitted public key of the server 10 (step S405). The user terminal 1 transmits the encrypted data to the server 10 as a first feature. The user terminal 1 may transmit the encrypted data in association with the user ID of the user 1. This operation is repeated by the number of users.

### At Matching

As illustrated in FIG. 10, first, the different server 20 transmits a service ID “SID(A)”. The user terminal 1 acquires a biometric feature y₁ of the user 1 wishing to be authenticated. Next, the user terminal 1 encrypts y₁ with the public key pk_{S} transmitted from the server 10 (step S406). The user terminal 1 transmits the encrypted feature y₁ as a second feature to the server 10 along with the service ID: SID(A). The server 10 calculates the similarity between the first feature(s) and the second feature (step S407). Because the calculated Enc(pk_{S}, D(x₁, y₁) ) has been encrypted with the public key pk_{S} of the server 10, the server 10 executes key conversion with the conversion key rk_{S→A} such that the different server 20 can decrypt Enc(pks, D(x₁, y₁) ) with its own secret key sk_{S} (step S408). Next, the server 10 transmits the encrypted similarity Enc(pk_{A}, D(x₁, y₁) ) to the different server 20. Next, the different server 20 executes a decryption process (step S409), and determines whether the decrypted D is a value that is within a predetermined range (step S410). Depending on the result, the different server 20 notifies the user terminal of a successful or unauthenticated authentication message.

### Another System Operation

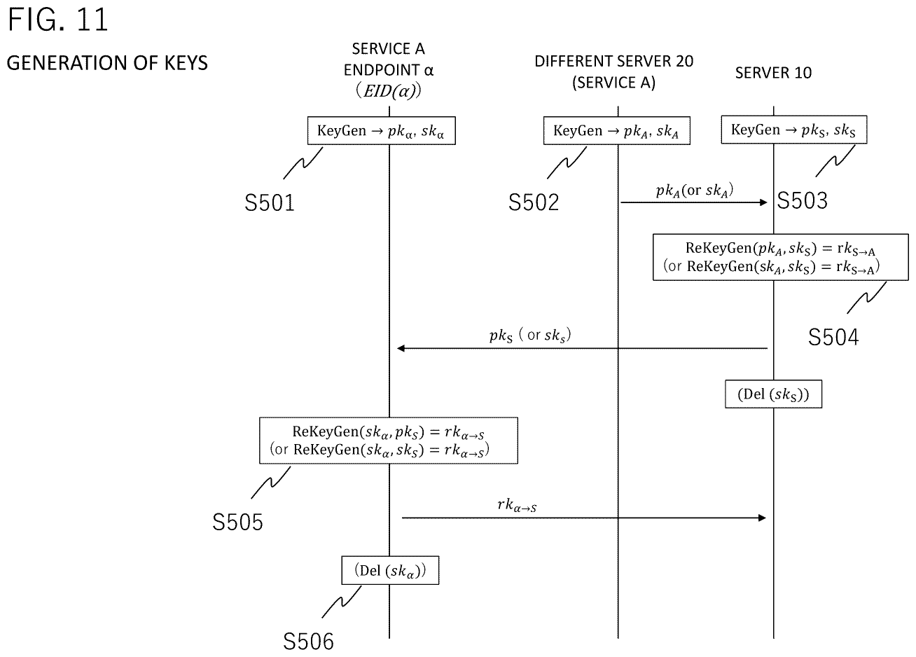

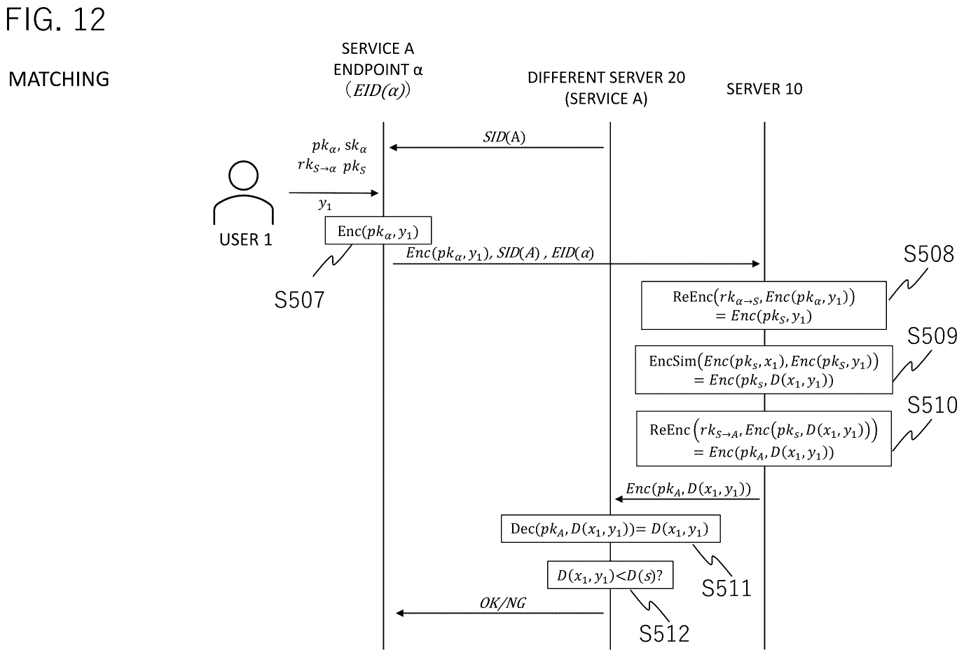

FIGS. 11 and 12 each illustrate a system operation executed when an endpoint is used. This “endpoint” is, for example, a terminal installed at a convenience store, and refers to a device that can receive an authentication service(s).

### Another System Operation: At Key Generation

As illustrated in FIG. 11, instead of the user terminal, an endpoint capable of handling the service A generates keys. This endpoint a generates a pair of a public key and a secret key (pk_{α}, sk_{α}) (step S501). In addition, a different server 20 generates a pair of a public key and a secret key (step S502), and the server 10 generates a pair of a public key and a secret key (step S503). As described above, the server 10 generates a conversion key rk_{S→A} (step S504). The endpoint a receives the public key pk_{S} (or sk_{S}) from the server 10, and generates a conversion key rk_{α→S} (step S505). The secret key sk_{α} may be deleted after the conversion key is generated (step S506).

### At Registration of Template

When a template is registered, biometric information of a user, the biometric information having been encrypted by a user terminal, can be transmitted to and stored in the server 10 as a first feature. In this case, because the same operation as in FIG. 9 is executed, redundant description thereof will be omitted.

### At Matching

As illustrated in FIG. 12, the endpoint a acquires biometric information of a user wishing to be authenticated, extracts a feature y₁, and encrypts the feature y₁ with its own public key pk_{α} (step S507). The endpoint a transmits the encrypted authentication query data to the server 10 along with a service ID: SID(A) and an endpoint ID: EID(α). The server 10 first executes key conversion from the encrypted second feature Enc(pk_{α}, y₁) into Enc(pk_{S}, y₁) by using the conversion key rk_{α→S} such that the encrypted second feature can be matched against the first feature(s) (step S508). Next, the server 10 calculates the similarity to the registered first feature(s) (step S509). Next, the server 10 executes key conversion from pk_{S} to pk_{A} such that the different server 20 can decrypt the similarity with its key (step S510). Next, as in FIG. 10, the different server 20 decrypts the similarity (step S511), and determines whether the similarity falls within an acceptance range (step S512). The endpoint α is notified of the determination result.

### Advantageous Effects

In the authentication system according to the present example embodiment, an individual user terminal encrypts and registers a first feature in the server 10. An individual second feature, which is an authentication query, is also encrypted, and the server 10 calculates the similarity between the encrypted first feature and the encrypted second feature. By converting the key used for the encrypted similarity, the corresponding different server 20 can decrypt the encrypted similarity with its own key. Thus, it is possible to realize high-level security, privacy, and high-speed processing as an authentication service.

Part or all of the above-described example embodiments can also be described as the following notes. However, each of the following notes is merely an example of the present invention, and therefore, the present invention is not limited to these notes.

### Note 1

See the server according to the above first aspect.

### Note 2

The server preferably according to note 1; wherein the calculation part calculates the similarity based on the encrypted first feature(s) and the encrypted second feature, each of which is encrypted.

### Note 3

The server preferably according to note 1 or 2, further including: a key generation part that generates a pair of a secret key and a public key; and a conversion key acquisition part that acquires a conversion key from the secret key generated by the key generation part and a key acquired from a different server.

### Note 4

The server preferably according to any one of notes 1 to 3; wherein the storage part stores a user ID(s) that determines a user(s) in association with a first feature(s); and wherein the conversion and transmission part transmits the similarity to a different server in association with the corresponding user ID.

### Note 5

See the authentication system according to the above second aspect.

### Note 6

The authentication system preferably according to note 5; wherein the different server decrypts the similarity and acquires a user ID associated with a highest similarity.

### Note 7

The authentication system preferably according to note 5 or 6, further including: a key generation part that generates a pair of a secret key and a public key; and a conversion key acquisition part that acquires a conversion key from the secret key generated by the key generation part and a key acquired from a different server.

### Note 8

The authentication system preferably according to any one of notes 5 to 7; wherein the different server transmits payment information including the one user ID to a payment server and receives payment result information from the payment server.

### Note 9

See the authentication method according to the above third aspect.

### Note 10

See the program according to the above fourth aspect.

The disclosure of the above PTL, etc., is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10: Server
11: Storage part
12: Acquisition part
13: Calculation part
14: Conversion and transmission part
15: Key generation part
16: Conversion key acquisition part
20,21,22: Server (group)
23, 25: User
24, 26: Terminal
301 CPU
302: Memory
303: Input-output interface
304: NIC
305: Internal bus

What is claimed is:

1. A server, comprising:
a storage part that stores an encrypted first feature(s);
an acquisition part that acquires a second feature received and encrypted by a terminal;
a calculation part that calculates a similarity based on the first feature(s) and the second feature; and
a conversion and transmission part that converts the similarity into a similarity in a format that can be decrypted by a different server, and transmits the converted similarity to the different server.

2. The server according to claim 1; wherein the calculation part calculates the similarity based on the encrypted first feature(s) and the encrypted second feature, each of which is encrypted.

3. The server according to claim 1, further comprising:
a key generation part that generates a pair of a secret key and a public key; and
a conversion key acquisition part that acquires a conversion key from the secret key generated by the key generation part and a key acquired from a different server.

4. The server according claim 1;
wherein the storage part stores a user ID(s) that determines a user(s) in association with a first feature(s); and
wherein the conversion and transmission part transmits the similarity to a different server in association with the corresponding user ID.

5. An authentication system, comprising:
a server; and
a different server;
wherein the server includes
a storage part that stores an encrypted first feature(s);
an acquisition part that acquires a second feature received and encrypted by a terminal,
a calculation part that calculates a similarity based on the first feature(s) and the second feature, and
a conversion and transmission part that converts the similarity into a similarity in a format that can be decrypted by a different server, and transmits the converted similarity to the different server;
wherein the storage part stores a user ID(s) that determines a user(s) in association with the first feature(s);
wherein the calculation part calculates the similarity based on the encrypted first feature(s) and the encrypted second feature, each of which is encrypted;
wherein the conversion and transmission part transmits the similarity to the different server in association with the corresponding user ID; and
wherein the different server decrypts the similarity and acquires one user ID based on the similarity and a predetermined reference.

6. The authentication system according to claim 5; wherein the different server decrypts the similarity and acquires a user ID associated with a highest similarity.

7. The authentication system according to claim 5, further comprising:
a key generation part that generates a pair of a secret key and a public key; and
a conversion key acquisition part that acquires a conversion key from the secret key generated by the key generation part and a key acquired from a different server.

8. The authentication system according to claim 5; wherein the different server transmits payment information including the one user ID to a payment server and receives payment result information from the payment server.

9. An authentication method, comprising:
causing a computer to store an encrypted first feature(s);
causing the computer to acquire a second feature received and encrypted by a terminal;
causing the computer to calculate a similarity based on the first feature(s) and the second feature; and
causing the computer to convert the similarity into a similarity in a format that can be decrypted by a different server, and to transmit the converted similarity to the different server.

10. (canceled)

11. The authentication method according to claim 9; wherein the computer calculates the similarity based on the encrypted first feature(s) and the encrypted second feature, each of which is encrypted.

12. The authentication method according to claim 9, further comprising:
causing the computer to generate a pair of a secret key and a public key; and
causing the computer to acquire a conversion key from the secret key and a key acquired from a different server.

13. The authentication method according to claim 9;
wherein the computer stores a user ID(s) that determines a user(s) in association with a first feature(s); and
wherein the computer transmits the similarity to a different server in association with the corresponding user ID.
